(19) United States
(12) Patent Application Publication
(10) Pub. No.: US 2026/0171319 A1
(43) Pub. Date: Jun. 18, 2026

(54) MULTILAYER ELECTRONIC DEVICE AND METHOD FOR MANUFACTURING THEREOF

(71) Applicant: TDK Corporation, Tokyo (JP)

(72) Inventors: Fumiaki SATOH, Tokyo (JP); Tsubasa AOKI, Tokyo (JP); Nobuto MORIGASAKI, Tokyo (JP); Masayuki TAKESHIGE, Tokyo (JP); Hitomi SATO, Tokyo (JP)

(73) Assignee: TDK Corporation, Tokyo (JP)

(21) Appl. No.: 19/413,371

(22) Filed: Dec. 9, 2025

(30) Foreign Application Priority Data
Dec. 12, 2024 (JP) 2024-217643

(51) Int. Cl. H01G 4/232; H01G 4/30

(52) U.S. Cl. CPC H01G 4/2325; H01G 4/30

(57) ABSTRACT

A multilayer electronic device having an exterior region 15 in which a first exterior region 15a and a second exterior region 15b are laminated continuously in a lamination direction, where the first exterior region contains “RB” in an amount greater than “RA” and the second exterior region 15b contains “RA” in an amount greater than that contained in the first exterior region 15a. The multilayer electronic device also includes an interior region 13, where a concentration of “RA” in an inner dielectric layer is higher than a concentration of “RA” in the first exterior region 15a, the second exterior region 15b and the interior region 13 are adjacent to each other in the lamination direction, and a thickness of the second exterior region 15b is 2 to 50 μm.

### TECHNICAL FIELD

The present disclosure relates to a multilayer electronic device such as a multilayer ceramic capacitor and a method for manufacturing thereof.

### BACKGROUND

For example, a technology disclosed in Patent Document 1 has been developed. According to a multilayer electronic device disclosed in Patent Document 1, moisture resistance can be improved and also cracks can be reduced during high voltage application.

### PRIOR ART DOCUMENT

### [Patent Document]

[Patent Document 1] JP Patent Application Laid Open No. 2024-76784

### SUMMARY

The present disclosure is achieved in view of such circumstances, and the object is to provide a multilayer electronic device not only capable of improving withstand voltage but also having uniformly high insulation resistance between inner electrodes in an element main body.

In order to achieve the above-mentioned object, a multilayer electronic device, includes: an element main body including an interior region where an inner dielectric layer and an inner electrode layer are laminated alternatingly and an exterior region positioned outside in a lamination direction of the interior region; and a pair of external electrodes connected to the inner electrode layer on a surface of the element main body; wherein the exterior region includes a first exterior region and a second exterior region continuously in a lamination direction, where the first exterior region contains a second group of rare-earth elements in an amount greater than a first group of rare-earth elements, and the second exterior region contains the first group of rare-earth elements in an amount greater than that contained in the first exterior region; the interior region has a higher concentration of the first group of rare-earth elements in the inner dielectric layer than a concentration of the first group of rare-earth elements in the exterior region; the second exterior region and the interior region are adjacent to each other in the lamination direction; and a thickness of the second exterior region is between 2 to 50 μm.

According to the multilayer electronic device, the exterior region includes the first exterior region and the second exterior region, where the first exterior region contains the first group of rare-earth elements and the second group of different rare-earth elements in an amount greater than the first group of rare-earth elements, and the second exterior region contains the first group of rare-earth elements in an amount greater than that included in the first exterior region. Further, the second exterior region is adjacent to the interior region in a lamination direction.

This second exterior region prevents the second group of rare-earth elements including Y and so on, which lots of these are included in the first exterior region, from diffusing into the interior region. Therefore, the concentration of the first group of rare-earth elements near the boundary between the second exterior region and the interior region can be maintained substantially the same as the concentration of the first group of rare-earth elements in the inner dielectric layer of the interior region.

As a result, insulation resistance of the inner dielectric layer positioned at the end in the lamination direction of the interior region (lamination end interior IR) is about the same as insulation resistance of the inner dielectric layer positioned near the center in the lamination direction of the interior region. Therefore, not only it is possible to improve withstand voltage as a multilayer electronic device but also possible to achieve uniformly high insulation resistance between inner electrodes in the element main body. The interior region may include a first interior region and a second interior region continuously in the lamination direction, where the first interior region may have a concentration of the second group of rare-earth elements contained in the inner dielectric layer being consistently lower, along the lamination direction, than a concentration of the second group of rare-earth elements contained in second exterior region; and the second interior region may have a concentration of the second group of rare-earth elements contained in the inner dielectric layer gradually increasing toward the exterior region compared to the concentration of the second group of rare-earth elements contained in the inner dielectric layer of the first interior region.

Preferably, the second exterior region and the second interior region may be adjacent to each other in the lamination direction; and the concentration of the second group of rare-earth elements contained in the inner dielectric layer of the second interior region may be lower than a concentration of the second group of rare-earth elements contained in the second exterior region.

Preferably, the concentration of the second group of rare-earth elements contained in the first exterior region may be higher than the concentration of the second group of rare-earth elements contained in the second exterior region. Also, a concentration of the first group of rare-earth elements contained in the second interior region may be equal to or lower than a concentration of the first group of rare earth elements contained in the first interior region.

For example, a boundary between the first exterior region and the second exterior region is defined as a position along the lamination direction of the exterior region having a concentration of the first group of rare-earth elements which is an average of a peak intensity corresponding to the concentration of the first group of rare-earth elements of the inner dielectric layer positioned near a center in the lamination direction of the element main body of the interior region and a peak intensity corresponding to the concentration of the first group of rare-earth elements near an end in the lamination direction of the exterior region.

Preferably, the first group of rare-earth elements may include at least one selected from the group consisting of Dy, Yb, Ho, Tb, Gd, and Eu; and the second group of rare-earth elements may include Y.

A method for manufacturing a multilayer electronic device according to one embodiment of the present disclosure, includes: forming of an element main body including an interior region where an inner dielectric layer and an inner electrode layer are laminated alternatingly, and an exterior region positioned outside in a lamination direction of the interior region, wherein the exterior region is formed by continuously laminating and baking, in a lamination direction, a first exterior green sheet corresponding to a first exterior region containing a second group of rare-earth elements in an amount greater than a first group of rare-earth elements, and a second exterior green sheet corresponding to a second exterior region containing the first group of rare-earth elements in an amount greater than in the first exterior region; and the interior region is formed by laminating an interior green sheet containing the first group of rare-earth elements in an amount greater than that contained in the first exterior region sheet together with an electrode paste layer for forming the inner electrode layer, and by baking the first exterior green sheet and the second exterior green sheet together.

According to the method for manufacturing the multilayer electronic device, the multilayer electronic device according to the embodiments of the aforementioned present disclosure can be easily produced.

Preferably, a thickness of a single sheet or a plurality of sheets configuring the second exterior green sheet may be 0.5 to 5 times of a thickness of a single sheet or a plurality of sheets configuring the interior green sheet positioned between the electrode paste layers adjacent to each other.

### BRIEF DESCRIPTION DRAWINGS

FIG. 1A is a schematic cross section view of a multilayer ceramic capacitor.

FIG. 1B is a schematic cross section view of the multilayer ceramic capacitor along an IB-IB line of FIG. 1A.

FIG. 2A is a mapping image of Dy of Example.

FIG. 2B is a graph showing a change in Dy amount of FIG. 2A.

FIG. 3 A is a mapping image of Y of Example.

FIG. 3B is a graph showing a change in Y amount of FIG. 3A.

### DETAILED DESCRIPTION

Hereinafter, embodiments of the present disclosure are explained.

### Overall Configuration of Multilayer Ceramic Capacitor

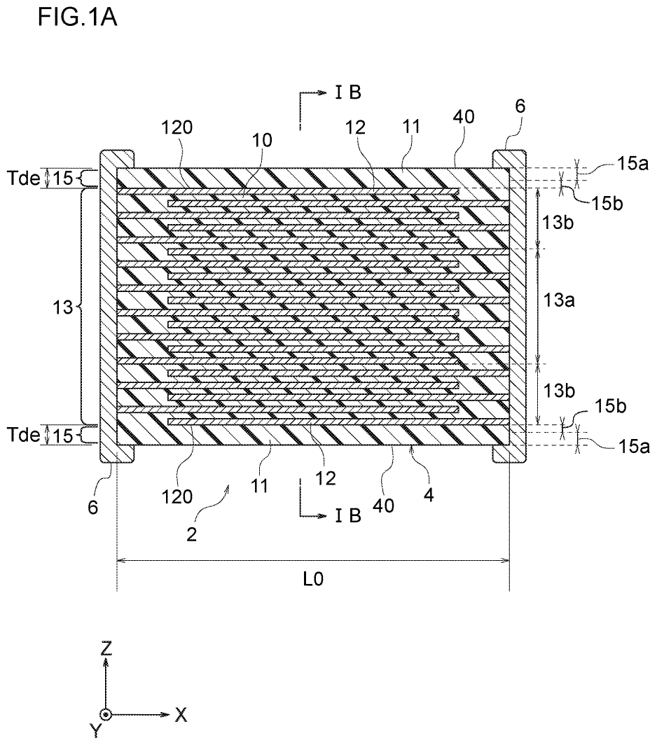

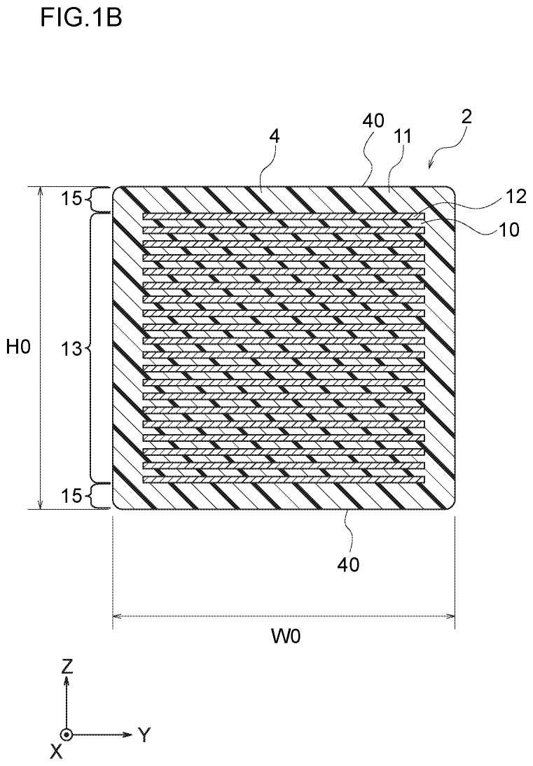

As shown in FIG. 1A and FIG. 1B, a multilayer ceramic capacitor 2 as an example of a multilayer electronic device according to the present embodiment includes an element main body 4; and the element main body 4 includes an interior region 13 and an exterior region 15.

The interior region 13 includes an inner dielectric layer 10 and an inner electrode layer 12 which are substantially parallel to a plane including an X-axis and a Y-axis. The inner dielectric layers 10 and the inner electrode layers 12 are alternatingly laminated along the Z-axis direction. The exterior region 15 is positioned outside in the lamination direction (Z-axis direction) of the interior region 13. At the outer end in the lamination direction (the lamination end) of the interior region 13, the inner electrode layer 12 of the lamination end is positioned; and in the present embodiment, the plane along the outer surface of the inner electrode layer 12 of the lamination end forms the boundary between the interior region 13 and the exterior region 15. The X-axis, the Y-axis, and the Z-axis are perpendicular to each other.

Also, “inner” refers to a side closer to the center of the multilayer ceramic capacitor 2, and “outer” refers to a side away from the center of the multilayer ceramic capacitor 2.

Further, “substantially parallel” means that mostly parallel and some parts may be nonparallel. The inner dielectric layer 10 and the inner electrode layer 12 may be somewhat uneven, or may be slanted.

As show in FIG. 1A, in the present embodiment, the end face in the X-axis direction of the element main body 4 is a flat surface; and the end face in the X-axis direction of the exterior region 15 is connected smoothly to the end face of the inner dielectric layer 10 and the end face of the inner electrode layer 12 in the X-axis direction. However, the end face in the X-axis direction of the element main body 4 does not necessarily have to be a flat surface, and it may include part which is not a flat surface. Also, the end face of the inner dielectric layer 10 in the X-axis direction and the end face of the inner electrode layer 12 in the X-axis direction may not be connected smoothly. For example, part of the end face of the inner dielectric layer 10 in the X-axis direction may be ground, or part of the inner electrode layer 12 may be protruding out to laminate the inner dielectric layer 10 and the inner electrode layer 12.

The exterior region 15 is configured using an outer dielectric layer 11. The exterior region 15 may be configured using a single layer of the outer dielectric layer 11, or it may be configured by laminating a plurality of outer dielectric layers 11. In the present embodiment, preferably the lamination structure is made by laminating the plurality of outer dielectric layers 11.

At both ends in the X-axis direction of the element main body 4, a pair of external electrodes 6 is formed, which electrically connect to the inner electrode layers 12 arranged in an alternating manner in the element main body 4. The element main body 4 may be in any shape, and usually it is a rectangular parallelepiped shape. Also, the element main body 4 may have any dimensions which is appropriately determined based on use.

In the present embodiment, a length L0 of the element main body 4 (see FIG. 1A) may be between 7.5 to 0.4 mm. In the present embodiment, a width W0 of the element main body 4 (see FIG. 1B) may be between 6.3 to 0.2 mm. In the present embodiment, a height HO of the element main body 4 (see FIG. 1B) may be between 6.3 to 0.05 mm.

Examples of the specific size of the element main body 4 include L0×W0 of (7.5±0.4) mm×(6.3±0.4) mm, (5.7±0.4) mm×(5.0±0.4) mm, (4.5±0.4) mm×(3.2±0.4) mm, (3.2±0.3) mm×(2.5±0.2) mm, (3.2±0.3) mm×(1.6±0.2) mm, (2.0±0.2) mm×(1.2±0.1) mm, (1.6±0.2) mm×(0.8±0.1) mm, (1.0±0.1) mm×(0.5±0.05) mm, (0.6±0.06) mm×(0.3±0.03) mm, and (0.4±0.04) mm×(0.2±0.02) mm. Also, HO is not particularly limited, and for example, it may be about the same as or smaller than W0.

### Inner Electrode Layer

In the present embodiment, the inner electrode layers 12 are alternatingly laminated such that the end parts in the X-axis direction of the inner electrode layers 12 are exposed to the two end surfaces, facing to each other, of the element main body 4.

The inner electrode layer 12 may include any conductor. Examples of precious metals used as the conductor include Pd, Pt, and an alloy of Ag—Pd. Examples of base metals used as the conductor include Ni, a Ni-based alloy, Cu, and a Cu-based alloy. Note that, various trace amount components such as P and/or S may be included in an amount of 0.1 mass % or less in Ni, a Ni-based alloy, Cu, and Cu-based alloy. Also, the inner electrode layer 12 may be formed using a commercially available electrode paste. A thickness of the inner electrode layer 12 may be determined appropriately according to its use.

### External Electrode

A conductor included in the external electrode 6 is not particularly limited. Examples of the conductor included in the external electrode 6 include Ni, Cu, Sn, Ag, Pd, Pt, Au, alloys thereof, and any known conductive resins. A thickness of the external electrode 6 may be determined appropriately according to its use.

### Dielectric Layer

In the present embodiment, “the inner dielectric layer 10” and “the outer dielectric layer 11” may be collectively referred to as “dielectric layer”.

A thickness of each inner dielectric layer 10 (interlayer thickness) is not particularly limited, and it may be set to any thickness according to desired property, use, and so on. Normally, the interlayer thickness may be 20 μm or thinner, 10 μm or thinner, or 5 μm or thinner. Also, the number of laminated inner dielectric layers 10 is preferably 10 layers or more. For example, it may be 50 layers or more, 100 layers or more, or 200 layers or more.

A thickness of each outer dielectric layer 11 (interlayer thickness) is not particularly limited, and it can be the same as the interlayer thickness of the inner dielectric layer 10. According to the multilayer ceramic capacitor 2 of the present embodiment, despite having a thin outer dielectric layer 11, the multilayer ceramic capacitor can achieve moisture resistance and can have less cracks during high voltage application. Also, the number of laminated outer dielectric layers 11 is not particularly limited. For example, it may be 5 layers or more, or 20 layers or more.

The dielectric layer (the inner dielectric layer 10 and the outer dielectric layer 11) according to the present embodiment includes main phase grains (dielectric particles).

The main phase grains of the present embodiment include a compound having a perovskite crystal structure represented by ABO₃ as a main component. The main component of the main phase grains is a component constituting 80 to 100 parts by mass, or preferably 90 to 100 parts by mass with respect to 100 parts by mass of the main phase grains. The main phase grains may include other components besides the main component. For example, the main phase grains may include a barium (Ba) compound.

In ABO₃, “A” that is an A-site element includes at least one selected from the group consisting of Ba, strontium (Sr), and calcium (Ca); and “A” may include at least one selected from the group consisting of Ba and Sr. One hundred parts by mole of “A” may include 80 parts by mole or more of Ba, or 90 parts by mole or more of Ba. Further, “A” may only include Ba.

In ABO₃, “B” that is a B-site element includes at least one selected from the group consisting of titanium (Ti), zirconium (Zr), and hafnium (Hf). “B” may include at least one selected from the group consisting of Ti and Zr. One hundred parts by mole of “B” may include 70 parts by mole or more of Ti, or 80 parts by mole or more of Ti. Further, “B” may include only Ti.

Provided that “A” includes at least one selected from the group consisting of Ba, Sr, and Ca and “B” includes at least one selected from the group consisting of Ti and Zr, the main component specifically has a composition of {(Ba_{1-x-y}CaₓSr_{y})O}ᵤ(Ti_{1-z}Zr₂)ᵥO₂.

In above, x is preferably 0≤x≤0.10, or more preferably 0≤x≤0.05. In above, y is preferably 0≤y≤0.10, or more preferably 0≤y≤0.05. In above, z is preferably 0≤z≤0.30, or more preferably 0≤z≤0.15. In above, u/v is preferably 1.000≤u/v≤1.030, or more preferably 0≤u/v≤1.015. When u/v is within the above-mentioned range, compared to the case that u/v is above the above-mentioned range, sintering can be performed sufficiently, thus relative permittivity and reliability of the dielectric composition tend to improve. When u/v is within the above-mentioned range, compared to the case that u/v is below the above-mentioned range, sintering stability is less likely to decrease; thus, relative permittivity, reliability, and a temperature characteristic of the multilayer ceramic capacitor 2 tend to further improve.

The dielectric layer includes “RE”, “M”, and silicon (Si) as a subcomponent. Note that, other than mentioned in above, Fe, Al, and/or Zr may be included as the subcomponent.

As mentioned above, the subcomponent may be present by being solid-dissolved in the main phase grain. The subcomponent may be solid-dissolved in the main phase grain to constitute a shell part of a core-shell structure or may be completely solid-dissolved in the main phase grain to form complete solid-dissolved main phase grain. Moreover, the subcomponent may constitute a segregation grain or may be found at grain boundaries between the main phase grains.

“RE” includes at least one selected from the group consisting of ytterbium (Yb), yttrium (Y), holmium (Ho), dysprosium (Dy), terbium (Tb), gadolinium (Gd), and europium (Eu); and preferably at least one selected from the group consisting of Dy, Ho, Yb, and/or Y.

Dy, Tb, Gd, and Eu have relatively large ionic radii among the above-mentioned rare-earth elements. Whereas Yb, Y, and Ho have relatively small ionic radii among the above-mentioned rare-earth elements. The larger the ionic radii of “RE”, the more readily “RE” tends to solid-dissolve in the main phase grain.

When “RE” having relatively large ionic radius solid-dissolves in the main phase grains, “RE” tends to be substituted for mainly the A-site element of the main component. By contrast, when “RE” having relatively small ionic radius solid-dissolves in the main phase grains, “RE” tends to be substituted for mainly the B-site element of the main component.

“M” includes at least two selected from the group consisting of magnesium (Mg), manganese (Mn), vanadium (V), and chromium (Cr). “M” is included in the dielectric layer mainly as oxide of “M”. “M” may be substituted for the B-site element of the main component.

The range of the composition of the main component of the main phase grains constituting the inner dielectric layers 10 and the range of the composition of the main component of the main phase grains constituting the outer dielectric layers 11 may be the same or different. The range of the composition of the subcomponent of the inner dielectric layers 10 excluding “RE” and the range of the composition of the subcomponent of the outer dielectric layers 11 excluding “RE” may be the same or different.

As shown in FIG. 1A, Tde denotes the distance between an outer surface 120 of an outermost layer of the inner electrode layers 12 and an outer surface 40 of the element main body 4, i.e., an outer surface of the exterior region 15. Note that, the outer surface 40 of the element main body 4 is a plane perpendicular to the lamination direction. Although Tde is not particularly limited, Tde is 10 μm or greater and 500 μm or smaller.

In the present embodiment, the outside of the exterior region 15 in the lamination direction is a first exterior region 15a. The range of the first exterior region 15a is not particularly limited, and for example, it can be defined as a part other than a second exterior region 15b among the exterior region 15 which is determined using a method described later.

The inner region in the lamination direction of the exterior region 15 is the second exterior region 15b. A thickness of the second exterior region 15b in the lamination direction is preferably 2 μm or thicker and 50 μm or thinner, or more preferably 2 μm or thicker and 20 μm or thinner.

Center of interior region 13 in the lamination direction is a first interior region 13a, and the interior region 13 positioned at the outside of the first interior region 13a in the lamination direction is second interior regions 13b. That is, the second interior regions 13b are regions included in the interior region 13. The areas of the second interior regions 13b are not particularly limited, and for example, preferably the second interior regions 13b are first to fifth layers toward the center from the inner dielectric layer 10 positioned at the lamination end along the Z-axis. The area of the first interior region 13a is not particularly limited, and for example, the area other than the second interior regions 13b among the interior region 13 can be the first interior region 13a.

Note that, in the present embodiment, outermost layers of the inner dielectric layers 10 are counted as first layers, and layers are counted as second layers, third layers, etc. in sequence inwards in the lamination direction. Thus, while one of the outermost layers of the inner dielectric layers 10 in the lamination direction is counted as one first layer, the other one of the outermost layers of the inner dielectric layers 10 in the lamination direction is also counted as another first layer. Also, the inner electrode layers 12 are also included in the first interior region 13a and the second interior regions 13b.

An element having a highest mole ratio among “RE” included in the inner dielectric layers 10 of the first interior region 13a is termed first rare-earth elements “RA”, and an element having a highest mole ratio among “RE” in the first exterior regions 15a is termed second rare-earth elements “RB”.

In the present embodiment, “RA” includes at least one selected from the group consisting of Yb, Ho, Dy, Tb, Gd, and Eu; and “RB” includes Y.

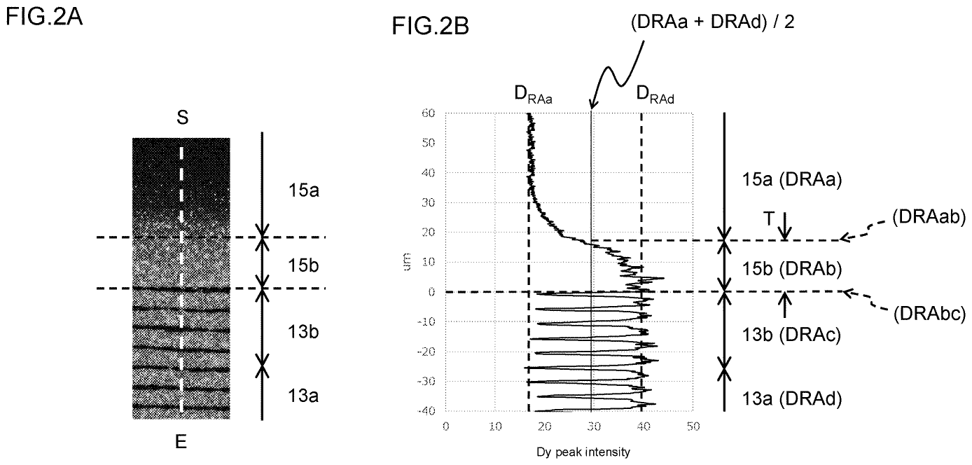

DRAa which represents an amount of “RA” in terms of RA₂O₃ with respect to 100 parts by mole of the main component in the first exterior regions 15a may have a portion which changes along the lamination direction and a portion which is roughly consistent (the outside along the lamination direction) as shown in FIG. 2B; and, the outside portion in the lamination direction may preferably be 1.0 parts by mole or less, more preferably 0.5 parts by mole or less, or it may substantially be 0. In the present embodiment, preferably the first exterior regions 15a include “RB” different from “RA” in a greater amount than “RA”.

DRAb which represents an amount of “RA” in terms of RA₂O₃ with respect to 100 parts by mole of the main component in the second exterior regions 15b preferably decreases towards the outside in the lamination direction (for example, see FIG. 2B), and preferably it may be 0.4 parts by mole or more and 7.0 parts by mole or less. In the present embodiment, the second exterior regions 15b preferably include “RA” in a greater amount than that included in the first exterior regions 15a.

DRAc which represents an amount of “RA” in terms of RA₂O₃ with respect to 100 parts by mole of the main component in the inner dielectric layers 10 of the second exterior regions 13b may change along the lamination direction; however, preferably it does not substantially change (for example, see FIG. 2B), and preferably it may be 0.4 parts by mole or more and 7.0 parts by mole or less.

DRAd which represents an amount of “RA” in terms of RA₂O₃ with respect to 100 parts by mole of the main component in the inner dielectric layers 10 of the first exterior regions 13a may change along the lamination direction; however, preferably it does not substantially change (for example, see FIG. 2B), and preferably it may be 0.4 parts by mole or more and 7.0 parts by mole or less.

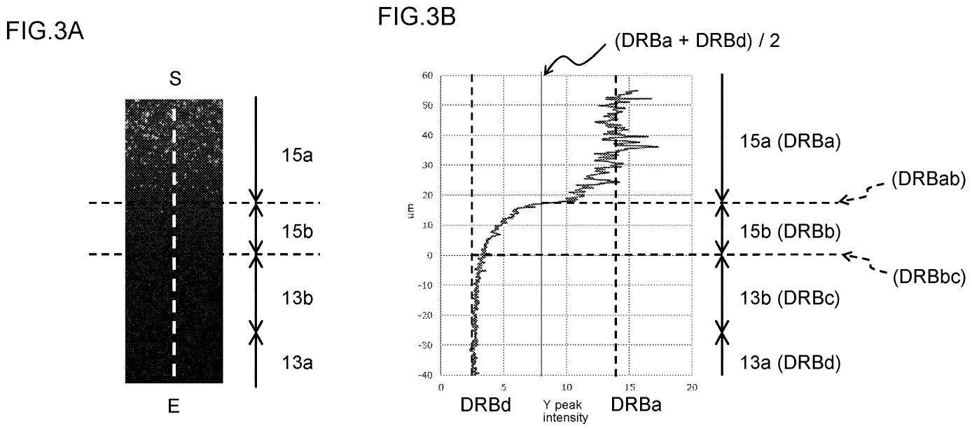

DRBa which represents an amount of “RB” in terms of RB₂O₃ with respect to 100 parts by mole of the main component in the first exterior regions 15a may have a portion which changes along the lamination direction and a portion which is roughly consistent (the outside along the lamination direction) as shown in FIG. 3B; and, the outside portion in the lamination direction may preferably have 0.4 parts by mole or more and 7.0 parts by mole or less

DRBb which represents an amount of “RB” in terms of RB₂O₃ with respect to 100 parts by mole of the main component in the second exterior regions 15b may increase toward the outside in the lamination direction as shown in FIG. 3B; and, preferably it may be 0.4 parts by mole or more and 7.0 parts by mole or less.

DRBc which represents an amount of “RB” in terms of RB₂O₃ with respect to 100 parts by mole of the main component in the inner dielectric layer 10 of the second interior regions 13b may increase toward the outside in the lamination direction as shown in FIG. 3B, and the smaller the amount of change, the more preferable. The DRBc may be 1.0 parts by mole or less, more preferably 0.5 parts by mole or less, or it may be substantially 0.

DRBd which represents an amount of “RB” in terms of RB₂O₃ with respect to 100 parts by mole of the main component in the inner dielectric layer 10 of the first interior regions 13a preferably barely changes along the lamination direction as shown in FIG. 3B, and preferably it may be 1.0 parts by mole or less, more preferably 0.5 parts by mole or less, or it may be substantially 0.

The above-mentioned DRAa, DRAb, DRAc, and DRAd satisfy the relation of DRAa<DRAb<DRAc≤DRAd. Also, the above-mentioned DRBa, DRBb, DRBc, and DRBd satisfy the relation of DRBa>DRBb>DRBc≥DRBd.

Further, in the present embodiment, as shown in FIG. 2B, the concentrations DRAc and DRAd of the first group of rare-earth elements “RA” included in the inner dielectric layer are higher than a concentration DRAab of the first group of rare-earth elements “RA” in the boundary between the first exterior regions 15a and the second exterior regions 15b. Note that, in the present embodiment, the concentration of “RA” or “RB” is used synonymously as an amount in terms of oxide with respect to 100 parts by mole of the main component as mentioned in above, or as the peak intensities shown in FIG. 2B or FIG. 3B.

Also, a concentration DRAbc of the first group of rare-earth elements “RA” near the boundary (the area within 0.5 μm to the second exterior regions near the boundary/hereinafter, the same is applied) between the second exterior regions 15b and the interior region 13 (the second interior region 13b) is substantially the same concentrations (DRAc and DRAd) of the first group of rare-earth elements “RA” in the inner dielectric layers of the interior region 13. Note that, substantially the same means that the difference between the two is within ±10% provided that the range of DRAd-DRAa is 100%.

Further, in the present embodiment, as shown in FIG. 3B, the concentrations DRBc and DRBd of the second group of rare-earth elements included in the inner dielectric layer are lower than a concentration DRBab of the second group of rare-earth elements “RB” in the boundary between the first exterior regions 15a and the second exterior regions 15b.

Also, a concentration DRBbc of the second group of rare-earth elements near the boundary between the second exterior region 15b and the interior region 13 (the second interior region 13b) becomes substantially the same as the concentration of the first group of rare-earth elements “RB” (DRBc and DRBd) in the inner dielectric layer of the interior region 13. Note that, “becomes substantially the same” means that the difference between the two is within ±10% provided that the range of DRBa-DRBd is 100% in the peak intensities shown in FIG. 3B.

FIG. 2A shows a mapping image of “RA” (Dy) obtained using STEM-EDS to a field of view including the first exterior regions 15a, the second exterior regions 15b, the second interior regions 13b, and the first interior region 13a. Also, FIG. 2B shows a change in a contrast intensity along the point S to the point E shown in FIG. 2A. In FIG. 2B, a horizontal axis shows the contrast intensity, and the vertical axis shows the distance. The unit of the vertical axis is μm, and the boundary between the inner electrode layer and the exterior region 15 is 0.

FIG. 3A is a mapping image of the elements obtained using STEM-EDS regarding “RB” (Y) in the same field of view as FIG. 2A; and FIG. 3B is a graph showing the change in the contrast intensity along the point S to the point E of FIG. 3A. In FIG. 3B, a horizontal axis shows the contrast intensity, and the vertical axis shows the distance. The unit of the vertical axis is μm, and the boundary between the inner electrode layer and the exterior region 15 is 0.

In the present embodiment, as shown in FIG. 2B and FIG. 3B, the concentrations of “RA” and “RB” gradually change from the first exterior regions 15a to the second exterior regions 15b.

In the present embodiment, DRAa and DRBa can be obtained as average values which are obtained by analyzing the region within 50 μm from the outer surface in the lamination direction in the exterior regions 15. DRAc and DRBc can be obtained as average values which are obtained by analyzing the region from the first layer to the fifth layer of the interior region 13. DRAd and DRBd can be obtained as average values which are obtained by analyzing the region within fifth layers toward outside from the center of the element of the interior region 13.

Note that, when DRAc, DRBc, DRAd, and DRBd of the first and second interior regions are calculated, the average contrast intensities of portions not including the inner electrode layers in the measurement ranges, i.e., the average contrast intensities of the inner dielectric layers in the measurement ranges, are calculated.

Further, in the present embodiment, as shown in FIG. 2B, the position where the intensity of “RA” (Dy) is the average of DRAa and DRAd can be the boundary between the first exterior region 15a and the second exterior regions 15b. Further, the distance from the outside in the lamination direction of the inner electrode layer to the boundary, that is, a thickness T of the second exterior region 15b is 2 to 50 μm, 2 to 20 μm, or preferably 4 to 15 μm. Note that, when the point which is the average of DRAa and DRAd is only found in the interior region 13 side, then the thickness T is 0, and the second exterior region is deemed non-existent. DRAb and DRBb can be obtained based on the average obtained by analyzing the range of the second exterior regions 15b obtained as discussed in above.

An “RE” amount of the first exterior regions 15a in terms of RE₂O₃ in 100 parts by mass of the first exterior regions 15a is termed CREa. As mentioned earlier, in the present embodiment, “RE” includes at least one selected from the group consisting of Yb, Y, Ho, Dy, Tb, Gd, and Eu. Thus, “RE” may include both “RA” and “RB”. CREa is preferably 0.4 parts by mass or more and 7.0 parts by mass or less.

DRBa, which is the “RB” amount of the first exterior regions 15a in terms of RE₂O₃ with respect to 100 parts by mole of the main component in the first exterior regions 15a, is preferably 0.7 parts by mole or more. DRAc, which is the “RA” amount in terms of RE₂O₃ with respect to 100 parts by mole of the main component in the second interior regions 13b, is preferably 0.7 parts by mole or more. DRAc and DRAa preferably satisfy DRAc/DRAa≥3.

### Method for Manufacturing Multilayer Ceramic Capacitor

Next, a method for manufacturing the multilayer ceramic capacitor 2 shown in FIG. 1A is described below as one example.

Similarly to a conventional multilayer ceramic capacitor, the multilayer ceramic capacitor 2 of the present embodiment is manufactured by forming a green chip with a normal printing or sheet method using pastes, firing the green chip, printing or transferring external electrodes onto the fired chip, and baking the chip again. Details of the manufacturing method are provided below.

First, dielectric raw materials for forming the first interior region 13a are prepared and are turned into paste to give a first interior paste.

As the dielectric raw materials, raw materials of ABO₃ as a main component and raw materials of other various oxides are prepared. As these raw materials, oxides of the above-mentioned components, mixtures and composite oxides thereof can be used. Additionally, the raw materials can be appropriately selected from various compounds (such as carbonates, oxalates, nitrates, hydroxides, and organic metal compounds) that become these oxides or composite oxides by firing, and the selected compounds can be mixed for use.

The particle size of a raw material powder of ABO₃ (main component) is not limited and is, for example, 150 to 300 nm.

In the present embodiment, preferably, a mixture in which the oxides or the like of the above-mentioned components are evenly dispersed relative to the main component is used. Also, the dielectric raw materials which the main component is covered with the above-mentioned components may be used as well. As raw materials other than those of the main component, for example, oxides of “RE”, oxides of “M”, or Si compounds may be used.

As the raw materials of ABO₃ (main component), those manufactured using a so-called solid phase method or using various liquid phase methods (such as an oxalate method, a hydrothermal synthesis method, an alkoxide method, and a sol-gel method) can be used.

In terms of BaCO₃, a BaCO₃ powder may be included at 0.1 parts by mole or more and 2.0 parts by mole or less with respect to 100 parts by mole of the main component.

Among the raw materials of the other various oxides, any two or more may be mixed and calcined before being mixed with the main component. For example, the raw materials of oxides of “RE”, raw materials of Si oxides, and raw materials of oxides of “A” included apart from the main component (e.g., raw material of Ba oxide) may be mixed in advance and calcined. The calcination temperature is less than 1100° C. Then, a compound powder resulting from calcination, the main component, and the uncalcined raw materials of the various oxides may be mixed. This brings a change of easiness for “RE” to solid-dissolve in the main phase grains.

In the first interior paste, the amount of a compound in terms of RE₂O₃ that becomes “RA” after firing is larger than the amount of a compound in terms of RE₂O₃ that becomes “RE” excluding “RA” after firing of the rare-earth compound. Also, the first interior paste may include “RB” (Y); however preferably, it is not substantially included. The amount of each compound of elements other than “RE” in the first interior paste is determined so that the dielectric layers have the above-mentioned composition after firing.

The first interior paste may be an organic paste in which the dielectric raw materials and an organic vehicle are kneaded, or may be an aqueous paste.

The organic vehicle is a vehicle made from an organic solvent in which a binder is dissolved. For the binder and the solvent, any known ones may be used.

When the first interior paste is an aqueous paste, the dielectric raw materials and an aqueous vehicle in which an aqueous binder, dispersant, or the like is dissolved in water are kneaded. Any aqueous binder may be used. For example, polyvinyl alcohol, cellulose, or aqueous acrylic resin may be used.

A second interior paste is prepared simultaneously, or before or after preparing the first interior paste. The second interior paste may preferably be the exact same as the first interior paste, or it may be different.

The first exterior paste is prepared simultaneously, or before or after preparing the second interior paste. The first exterior paste and the first interior paste may be the same except for the points described below. The first exterior paste contains the second group of rare-earth elements “RB” in a greater amount than the first group of rare-earth elements “RA”; and, preferably the first exterior paste substantially does not contain the first group of rare-earth elements “RA”. The dielectric raw materials of the main component and the subcomponent (additive component) other than the rare-earth elements in the first exterior paste may be the same as or different from those included in the first interior paste.

The second exterior paste is prepared simultaneously, or before or after preparing the first exterior paste. The second exterior paste and the first exterior paste may be the same except for the points described below. The second exterior paste contains the first group of rare-earth elements “RA” in a greater amount than the second group of rare-earth elements “RB”; and, preferably the first exterior paste substantially does not contain the second group of rare-earth elements “RB”. A second exterior green sheet formed using the second exterior paste prevents “RB” contained in a first exterior green sheet formed using the first exterior paste from diffusing into the interior region 13.

An inner electrode layer paste is prepared by kneading a conductor made of Ni, Ni alloys, etc. mentioned above or various oxides, organic metal compounds, resinates, etc. that become Ni, Ni alloys, etc. mentioned above after firing with the above-mentioned organic vehicle. The inner electrode layer paste may include an inhibitor. Any inhibitor may be used. The inhibitor may have the same composition as the main component.

An external electrode paste is prepared using a conductor or the like made of Cu, Cu alloys, etc. mentioned above as an inorganic component, similarly to the inner electrode layer paste.

An amount of the organic vehicle in each of the above pastes is not particularly limited and is a normal amount. For example, the binder accounts for about 1 to 15 mass %, and the solvent accounts for about 10 to 60 mass %. Each paste may include additives selected from, for example, various dispersants, plasticizers, dielectrics, and insulators as necessary. The total additive amount of these may be 10 mass % or less.

The first exterior paste is used on a substrate film (substrate) such as PET to form a green sheet, then it is released form the substrate to make the first exterior green sheet. Also, the second exterior paste is used on a substrate to form a green sheet, then it is released form the substrate to make the second exterior green sheet. The second exterior green sheet is laminated on the laminated first exterior green sheet, then pressure is applied in the lamination direction to obtain an exterior green multilayer body. The first exterior green sheet and the second exterior green sheet may be respectively configured of a single sheet or it may be configured of a plurality of sheets.

A thickness of the single sheet or the plurality of sheets configuring the second exterior green sheet is preferably thinner than a thickness of the single sheet or the plurality of sheets configuring the first exterior green sheet. Also, the thickness of the single sheet or the plurality of sheets configuring the second exterior green sheet is preferably 0.5 to 5 times the thickness of the single sheet or the plurality of sheets configuring the interior green sheet positioned between the adjacent inner electrode paste layers.

Also, at the same time of obtaining the exterior green multilayer body, or before or after thereof, the green sheet is formed on the substrate using the second interior paste, and the inner electrode pattern layer is formed on the green sheet using the inner electrode layer paste. Then, the green sheet is released form the substrate; and thereby, the second interior green sheet having the inner electrode pattern layer is made.

At the same time of forming the second interior green sheet, or before or after thereof, the green sheet is formed on the substrate using the first interior paste, and the inner electrode pattern layer is formed on the green sheet using the inner electrode layer paste. Then, the green sheet is released form the substrate; and thereby, the first interior green sheet having the inner electrode pattern layer is made.

As a method for forming the internal electrode pattern layer, any method may be used. The inner electrode pattern layer may be formed using a printing method or a transfer method, or by thin film formation methods such as vapor deposition and sputtering.

Next, a plurality of second interior green sheets having the inner electrode pattern layers is laminated, and thereon, a plurality of first interior green sheets having the inner electrode pattern layers is laminated. Further, a plurality of second interior green sheets having the inner electrode pattern layers is laminated thereon. Then, the interior green multilayer body is obtained by carrying out pressure adhesion as necessary.

Next, the interior green multilayer body is placed between a pair of exterior green multilayer bodies, then pressure is applied in the lamination direction to give the green multilayer body of the element main body 4. Note that, when placing the interior green multilayer body between the pair of exterior green multilayer bodies, the second exterior green sheet side of the exterior green multilayer bodies contacts each end in the lamination direction of the interior green multilayer body.

Note that, in the above-mentioned example, the exterior green multilayer bodies and the interior green multilayer body are formed separately and then combined; however, it is not limited to this, and an exterior green multilayer body may be formed, and then an interior green multilayer body may be formed continuously followed by forming another exterior green multilayer body.

The green multilayer body of the element main body 4 is cut into a predetermined shape and then released from a substrate to give green chips.

The green chips are subject to a binder removal treatment before being fired. The binder removal conditions are not particularly limited, and the temperature increasing rate is preferably 5 to 300° C./hour; the binder removal temperature is preferably 180 to 900° C.; and the holding time is preferably 0.5 to 48 hours. Also, the atmosphere of the binder removal treatment is in the air or a reducing atmosphere (e.g., a humidified N₂ gas or a humidified N₂+H₂ mixed gas).

After binder removal, the green chips are fired. The firing conditions are not particularly limited; and for example, the temperature increasing rate may be 200 to 20000° C./hour; the firing temperature may be 1150 to 1350° C.; and the holding time may be 0.1 to 10 hours.

The atmosphere of firing is not particularly limited. The atmosphere of firing is not limited and may be in the air or a reducing atmosphere. As an ambient gas for the reducing atmosphere, for example, a humidified mixed gas of N₂ and H₂ can be used. The oxygen partial pressure may be 1.0×10⁻¹⁴ to 1.0×10⁻⁹ MPa.

In the present embodiment, the element main body 4 after being fired is preferably subject to an annealing treatment (oxidation treatment of the dielectric layers). Specifically, the annealing temperature may be between 950 to 1100° C. The holding time may be between 0.1 to 20 hours. The atmosphere of the oxidation treatment may be a humidified N₂ gas (oxygen partial pressure: 1.0×10⁻⁹ to 1.0×10⁶ MPa).

In the binder removal treatment, firing, and annealing treatment described above; for example, a wetter is used to humidify the N₂ gas, mixed gas, etc. In such a case, the water temperature is preferably about 5 to 75° C.

The binder removal treatment, firing, and annealing treatment may be performed continuously or independently.

The end surfaces of the element main body 4 obtained as above are polished by, for example, barrel polishing or sandblasting, and the external electrode paste is applied and fired to give the external electrodes 6. As necessary, a coating layer is then formed on surfaces of the external electrodes 6 by plating or so.

The multilayer ceramic capacitor 2 of the present embodiment manufactured in such a manner is mounted on a printed circuit board or the like by soldering or so and is used in various electronics.

In a conventional multilayer ceramic capacitor, its exterior regions tend to readily have pores compared to the interior region. It is assumed that this is because sintering tends not to readily proceed in the exterior regions, as the exterior regions do not include inner electrode layers having high thermal conductivity whereas the interior region includes such inner electrode layers.

By contrast, the inner dielectric layers and the outer dielectric layers of the multilayer ceramic capacitor 2 according to the present embodiment have the compositions, particularly “RE” and its amount, satisfying the conditions described above, the exterior regions 15 can be sufficiently fired to have a reduced porosity for densification of the exterior regions 15, which can result in improvement of moisture resistance.

Also, in the multilayer ceramic capacitor 2 according to the present embodiment, the concentrations of “RA” and “RB” gradually change from the exterior regions 15 to the interior region 13 so that both DRAa<DRAb<DRAc≤DRAd and DRBa>DRBb>DRBc≥DRBd are satisfied. This causes a gradual change in the sintering behavior from the exterior regions 15 to the interior region 13, enabling reduction of difference between stress in the exterior regions 15 and stress in the interior region 13, which can result in reduction of electrostrictive cracks.

Further, in the present embodiment, the exterior regions 15 include the first exterior regions 15a and the second exterior regions 15b continuously in the lamination direction, where the first exterior regions 15a contain the second group of rare-earth elements “RB” in an amount greater than the first group of rare-earth elements “RA”, and the second exterior regions 15b including the first group of rare-earth elements “RA” in an amount greater than that included in the first exterior regions 15a. Further, the second exterior regions 15b are adjacent to the interior region 13 in the lamination direction.

This second exterior regions 15b prevent the second group of rare-earth elements “RB” containing Y and so on which lots of these are included in the first exterior regions 15a from diffusing into the interior region 13. Therefore, for example as shown in FIG. 2B, the concentration DRAbc of the first group of rare-earth elements “RA” near the boundary between the second exterior regions 15b and the interior region 13 can be maintained substantially the same as the concentration DRAd of the first group of rare-earth elements “RA” in the inner dielectric layer of the interior region 13. Also, as shown in FIG. 3B, the concentration DRBbc of the second group of rare-earth elements “RB” near the boundary between the second exterior regions 15b and the interior region 13 can be maintained substantially the same as the concentration DRBd of the second group of rare-earth elements “RB” in the inner dielectric layer of the interior region 13.

As a result, insulation resistance of the inner dielectric layer (lamination end interior IR) positioned at the end in the lamination direction of the interior region 13 is about the same as insulation resistance of the inner dielectric layer positioned near the center in the lamination direction of the interior region 13. Therefore, not only it is possible to improve withstand voltage as a multilayer electronic device but also possible to achieve uniformly high insulation resistance between inner electrodes in an element main body.

### MODIFIED EXAMPLE

Although the description of the embodiment of the present disclosure is provided above, the present disclosure is not at all limited to the above embodiment, and various modifications are possible without departing from the scope of the disclosure.

For example, “RA” or “RB” may be partly substituted for an inorganic component of the inner electrode layer paste. When not too much component of “RA” or “RB” is included in the inner electrode layer paste, the “RA” amount and the “RB” amount of the inner dielectric layers 10 of the interior region 13 can be controlled, which enables to readily satisfy DRAa<DRAb<DRAc≤DRAd and DRBa>DRBb>DRBc≥DRBd.

While the multilayer ceramic capacitor exemplifies the multilayer electronic device according to the present disclosure in the above embodiment, the multilayer electronic device according to the present disclosure is not limited to the multilayer ceramic capacitor and it may be any multilayer electronic device having the structure described above.

### Examples

Hereinafter, the present disclosure is described in further detail with Examples and Comparative Examples. However, the present disclosure is not limited to Examples described below.

### Example 1

A first interior paste was prepared as follows.

As a raw material powder of the main component, a BaTiO₃ powder was prepared. The BaTiO₃ powder had a Ba/Ti ratio of 1.000. As raw material powders of the subcomponent, SiO₂, BaCO₃, MgO powder, MnCO₃ powder, V₂O₅ powder, and an oxidized powder of the first group of rare-earth elements (Dy) were prepared.

Then, the raw material powders prepared as above were weighed so that the SiO₂ powder was 1.0 part by mol, the BaCO₃ powder was 1.0 part by mol, and a mixture of the MgO powder, MnCO₃ powder, and V₂O₅ powder was 0.7 parts by mole in terms of the oxides with respect to 100 parts by mole of the main component. Also, the raw material powders of “RE” were weighed so that these were as shown in Table 1 in terms of the oxides with respect to 100 parts by mole of the main component. The weighed raw material powders were wet-mixed and pulverized using a ball mill for 20 hours and dried to give a dielectric raw material.

Then, polyvinyl butyral resin (10 parts by mass), dioctyl phthalate (DOP) as a plasticizer (5 parts by mass), and alcohol as a solvent (100 parts by mass) were mixed with 100 parts by mass of the dielectric raw material using a ball mill. The mixture was turned into a paste to give the first interior paste.

A second interior paste, a first exterior paste, and a second exterior paste were prepared similarly to the first interior paste except that the raw material powders of oxides of “RE” and their amounts in the pastes were changed as shown in Table 1.

A Ni powder, terpineol, ethyl cellulose, and benzotriazole were prepared so that the mass ratio was 44.6:52.0:3.0:0.4. These were kneaded using a three-roller mill and turned into a paste to give an inner electrode layer paste.

A first exterior green sheet was formed using the first exterior paste produced as above on a PET film so as to have a thickness of 6.0 μm after being dried. Also, a second exterior green sheet was formed using the second exterior paste on a PET film so as to have a thickness of 2.0 μm after being dried. A single second exterior green sheet was laminated on the laminated first exterior green sheets, then pressure was applied in the lamination direction to give an exterior green multilayer body.

At the same time of forming the exterior green multilayer body, or before or after thereof, green sheets were formed using the first interior paste produced as above so as to have a thickness of 4.0 μm after being dried, and electrode layers were printed on the green sheets in predetermined patterns using the inner electrode layer paste. Then, the sheets were released from the PET film; and thereby, the first interior green sheet having the inner electrode pattern layers was made.

Also, green sheets were formed using the second interior paste produced as above so as to have a thickness of 4.0 μm after being dried, and electrode layers were printed on the green sheets in predetermined patterns using the internal electrode layer paste. Then, the sheets were released from the PET film; and thereby, the second interior green sheet having the inner electrode pattern layers was made.

Next, five second interior green sheets were laminated on the second exterior green sheet of the above-mentioned exterior green multilayer body, then thirty of first interior green sheets were laminated thereon, and five of second interior green sheets were further laminated. The above-mentioned exterior green multilayer body was laminated so that the second exterior green sheet side of the exterior green multilayer body contacts the second interior green sheet. Then, pressure adhesion was carried out to give the green multilayer body of the element main body 4. The green multilayer body was cut into a predetermined size to give green chips.

The green chips were subject to a binder removal treatment, firing, and an oxidation treatment to give element main bodies (sintered bodies).

As for the binder removal conditions, the temperature increasing rate was 25° C./hour; the binder removal temperature was 235° C.; the holding time was 8 hours; and the atmosphere was in the air.

As for the firing conditions, the temperature increasing rate was 200° C./hour; the holding temperature was 1280° C.; the holding time was 2 hours; and the temperature decreasing rate was 200° C./hour. The atmosphere was a humidified N₂+H₂ mixed gas. The oxygen partial pressure was about 5.0×10⁻¹¹ MPa.

As for the oxidation treatment conditions, the temperature increasing rate and the temperature decreasing rate were 200° C./hour; the oxidation treatment temperature was 1050° C.; the holding time was 3 hours; the atmosphere was a humidified N₂ gas; and the oxygen partial pressure was 1.0×10⁻⁷ MPa. A wetter was used for humidifying the respective gases used for firing and the oxidation treatment.

Then, after barrel polishing each end surface of the obtained element main body, a Cu paste was applied as external electrodes, and a baking treatment was performed in a reducing atmosphere to give a multilayer ceramic capacitor sample shown in FIG. 1A and

FIG. 1B. The obtained capacitor sample had a size of 3.2 mm×1.6 mm×0.7 mm. The inner dielectric layer had a thickness of 3.0 μm. The internal electrode layer had a thickness of 1.0 μm. The exterior region had a thickness (Tde) of 270 μm. The number of the inner dielectric layers was 40.

### (STEM-EDS Analysis)

The element main body 4 was cut along its lamination direction, and the resulting section was polished to give a polished surface. Then, the polished surface was thinned using focused ion beam (FIB). The thinned sample for measurement was subject to mapping analysis using a scanning transmission electron microscope (STEM) having an energy-dispersive X-ray spectroscopy (EDS) device attached. According to the mapping analysis result, it was confirmed that “RA” was Dy, and “RB” was Y. Further, the data relating to the intensity of “RA” as shown in FIG. 2B and the intensity data of “RB” as shown in FIG. 3B along the lamination direction were obtained.

Based on the obtained datum, DRAa and DRBa were obtained. Similarly, DRAc, DRBc, DRAd, and DRBd were obtained. The position giving the medium intensity between the DRAa and DRAd were deemed to be the boundary between the first exterior region 15a and the second exterior region 15b; then, the thickness T of the second exterior region 15b, and DRAb and DRBb were obtained. Further, the intensity data of “RA” near the boundary between the second exterior region 15b and the interior region 13 (the second interior region 13b) was also obtained.

In Table 2, when relations of DRAa<DRBa, DRAa<DRAb, DRAa<DRAc, DRAbc≈DRAd (substantially the same), DRAa<DRAb<DRAc≤DRAd, and DRBa>DRBb>DRBc≥DRBd were satisfied, the table shows “Y”, and when these relations were not satisfied, the table shows “N”.

### (Withstand Voltage)

A DC voltage was applied to the multilayer ceramic capacitor sample, and a voltage at which a short circuit occurred when the applied voltage was increased was deemed to be the withstand voltage. Samples were rated as “NG” when the withstand voltage was less than 150, “B” when the withstand voltage was between 150 V or greater and less than 200 V, or “A” when the withstand voltage was 200 V or greater. It can be determined that the higher the withstand voltage, the higher the effectiveness of reducing electrostrictive cracks. The results are shown in Table 2.

### (Lamination End Interior IR)

Regarding the obtained multilayer ceramic capacitor sample, the external electrodes were polished to expose the inner electrodes. Using pin probes, the pair of inner electrodes adjacent to the inner dielectric layer positioned outside in the lamination direction was contacted with the terminals to measure electric resistance (IR). Specifically, at room temperature (20° C.), 50V of DC voltage was applied to the capacitor sample for 30 seconds, and resistance (Ω) of the outermost region of the capacitor sample was measured using insulation resistance meter. This measurement was performed to ten capacitor samples, and for each condition, the average of the measurement results (average resistance) was calculated as the lamination end interior IR. Also, regarding these capacitor samples, pin probes were contacted with the pair of inner electrodes closest from the center in the lamination direction to measure electric resistance of the center part. Here, provided that the average resistance of the center part of the same chip was used as a standard, when the resistance was less than 80%, it was labeled “NG” and 80% or greater was labeled as “A”. The results are shown in Table 2.

### (Evaluation)

The multilayer ceramic capacitor samples which at least one of withstand voltage and lamination end interior IR was evaluated as “NG” were evaluated as “NG” (Comparative Examples). The multilayer ceramic capacitor samples which the withstand voltage was “B” and lamination end interior IR was “A” were evaluated as “A” (Examples).

When both the withstand voltage and lamination end interior IR were “A”, the multilayer ceramic capacitor samples were evaluated as “AA” (Examples). The results are shown in Table 2.

### Comparative Example 1

In Comparative Example 1, the multilayer ceramic capacitor was obtained and evaluated as similar to that of Example 1 except that, as shown in Table 1, the type and the amount of “RE” in the first exterior paste were changed to the same type and the same amount of “RE” used in the first interior paste. The results are shown in Table 2.

### Comparative Example 2

In Comparative Example 2, the multilayer ceramic capacitor was obtained and evaluated as similar to that of Example 1 except that a green sheet having the same composition as the first exterior green sheet was used as the second exterior green sheet. The results are shown in Table 2.

### Examples 2 to 6 and Comparative Example 3

In Examples 2 to 6 and Comparative Example 3, the multilayer ceramic capacitor was obtained and evaluated as similar to that of Example 1 except that an interlayer ratio of sheets shown in Table 1, that is the number of layers of second exterior green sheets with respect to the first interior green sheets, was adjusted to the thickness T of the second exterior region to give the value shown in Table 2. The results are shown in Table 2.

### Comparative Example 4

In Comparative Example 4, the multilayer ceramic capacitor was obtained and evaluated as similar to that of Example 1 except that, as shown in Table 1, the type and the amount of “RE” was changed to Tb from Dy, and Tb₇O₄ was used instead of Dy₂O₃. The results are shown in Table 2.

### Example 7

In Example 7, the multilayer ceramic capacitor was obtained as similar to that of Example 2 except that Tb₇O₄ was used instead of Dy₂O₃, and the evaluations similar to Example 1 were carried out. The results are shown in Table 2.

TABLE 1

| | | | | | Interlayer |
|---|---|---|---|---|---|
| | RE content in First | RE content in Second | RE content in Second | RE content in First | ratio of |
| | exterior paste | exterior paste | interior paste | interior paste | sheets |
| Comparative | Dy2O3: 4.0 parts by mol | Same as indicated in left | Same as indicated in left | Same as indicated in left | 0.5 |
| example 1 | | | | | |
| Comparative | Y2O3: 1.5 parts by mol | Same as indicated in left | Dy2O3: 4.0 parts by mol | Same as indicated in left | 0.5 |
| example 2 | | | | | |
| Example 1 | Y2O3: 1.5 parts by mol | Dy2O3: 4.0 parts by mol | Same as indicated in left | Same as indicated in left | 0.5 |
| Example 2 | Y2O3: 1.5 parts by mol | Dy2O3: 4.0 parts by mol | Same as indicated in left | Same as indicated in left | 1 |
| Example 3 | Y2O3: 1.5 parts by mol | Dy2O3: 4.0 parts by mol | Same as indicated in left | Same as indicated in left | 2 |
| Example 4 | Y2O3: 1.5 parts by mol | Dy2O3: 4.0 parts by mol | Same as indicated in left | Same as indicated in left | 3 |
| Example 5 | Y2O3: 1.5 parts by mol | Dy2O3: 4.0 parts by mol | Same as indicated in left | Same as indicated in left | 4 |
| Example 6 | Y2O3: 1.5 parts by mol | Dy2O3: 4.0 parts by mol | Same as indicated in left | Same as indicated in left | 5 |
| Comparative | Y2O3: 1.5 parts by mol | Dy2O3: 4.0 parts by mol | Same as indicated in left | Same as indicated in left | 6 |
| example 3 | | | | | |
| Comparative | Tb7O4: 4.0 parts by mol | Same as indicated in left | Same as indicated in left | Same as indicated in left | 0.5 |
| example 4 | | | | | |
| Example 7 | Y2O3: 1.5 parts by mol | Tb7O4: 4.0 parts by mol | Same as indicated in left | Same as indicated in left | 1 |

TABLE 2

| | | | Thickness T | | | | | DRAa < | DRBa > | | | |
|---|---|---|---|---|---|---|---|---|---|---|---|---|
| | | | (μm) of | | | | DRAbc | DRAb < | DRBb > | | Lamination | |
| | Element | Element | Second | DRAa < | DRAa < | DRAa < | ≈ | DRAc ≤ | DRBc ≥ | Withstand | end interior | |
| | of RA | of RB | exterior region | DRBa | DRAb | DRAc | DRAd | DRAd | DRBd | voltage | IR | Rating |
| Comparative | Dy | Dy | — | N | N | N | Y | N | N | NG | A | NG |
| example 1 | | | | | | | | | | | | |
| Comparative | Dy | Y | — | Y | Y | Y | N | Y | Y | A | NG | NG |
| example 2 | | | | | | | | | | | | |
| Example 1 | Dy | Y | 4.5 | Y | Y | Y | Y | Y | Y | A | A | AA |
| Example 2 | Dy | Y | 9.0 | Y | Y | Y | Y | Y | Y | A | A | AA |
| Example 3 | Dy | Y | 18.0 | Y | Y | Y | Y | Y | Y | A | A | AA |
| Example 4 | Dy | Y | 27.0 | Y | Y | Y | Y | Y | Y | B | A | A |
| Example 5 | Dy | Y | 36.0 | Y | Y | Y | Y | Y | Y | B | A | A |
| Example 6 | Dy | Y | 45.0 | Y | Y | Y | Y | Y | Y | B | A | A |
| Comparative | Dy | Y | 54.0 | Y | Y | Y | Y | Y | Y | NG | A | NG |
| example 3 | | | | | | | | | | | | |
| Comparative | Tb | Tb | — | N | N | N | Y | N | N | NG | A | NG |
| example 4 | | | | | | | | | | | | |
| Example 7 | Tb | Y | 9.0 | Y | Y | Y | Y | Y | Y | A | A | AA |

According to the results shown in Table 1 and Table 2, Examples in which DRAa<DRBa, DRAa<DRAb, and DRAa<DRAc were satisfied, and the thickness T of the second exterior region 15b was within the predetermined range exhibited good withstand voltage and IR characteristic. Further, Examples in which DRAa<DRAb<DRAc≤DRAd and DRBa>DRBb>DRBc≥DRBd were satisfied, and the thickness T of the second exterior region 15b was within the predetermined rage exhibited good withstand voltage and IR characteristic (the lamination end interior IR).

According to FIGS. 2A, 2B, 3A, and 3B, it was confirmed that, particularly in Example 3, the concentrations of “RA” (Dy) and “RB” (Y) gradually changed from the first exterior region 15a to the second exterior region 15b which satisfied the above relations.

Also, as shown in FIG. 2B, the concentration DRAbc of the first group of rare-earth elements “RA” near the boundary between the second exterior regions 15b and the interior region 13 can be maintained substantially the same as the concentration DRAd of the first group of rare-earth elements “RA” in the inner dielectric layer of the interior region 13 (that is, DRAbc≈DRAd). Further, as shown in FIG. 3B, the concentration DRBbc of the second group of rare-earth elements “RB” near the boundary between the second exterior regions 15b and the interior region 13 can be maintained substantially the same as the concentration DRBd of the second group of rare-earth elements “RB” in the inner dielectric layer of the interior region 13. Such tendencies were also observed in the results of Examples 1, 2, and 4 to 7.

As such, it is assumed that, in Examples 1 to 7, a gradual change in the sintering behavior from the first exterior regions 15a to the second exterior regions 15b, hence this enables to reduce difference between stress in the exterior region 15 and stress in the interior region 13, which resulted in a good withstand voltage, i.e., reduction of electrostrictive cracks. Also, in Examples, diffusion of Y into the interior region 13 was prevented, which resulted in maintaining high IR characteristic (lamination end interior IR).

In Comparative Example 1, the element included as “RA” and the element included as “RB” were both Dy. It is assumed that, in Comparative Example 1, this resulted in no concentration gradient of “RA” or “RB” from the exterior regions to the interior region, not allowing for reduction of difference in the sintering behavior between the exterior regions and the interior region, which caused stress to remain inside the chip and lead to “NG” rating of the withstand voltage.

Further, Comparative Example 2 satisfied DRAa<DRAb<DRAc≤DRAd and DRBa>DRBb>DRBc≥DRBd; however, the thickness T of the second exterior region was thinned down. In Comparative Example 2, Y included in the first exterior paste diffused into the second interior region 13b, which was thought to have resulted in poor lamination end interior IR. Also, in Comparative Example 2, DRAbc was not substantially the same as DRAd.

Comparative Example 3 satisfied DRAa<DRAb<DRAc≤DRAd and DRBa>DRBb>DRBc≥DRBd; however, the thickness T of the second exterior region was thickened. It is assumed that, similarly to Comparative Example 1, in Comparative Example 3, this resulted in no concentration gradient of “RA” or “RB” from the exterior regions to the interior region, not allowing for reduction of difference in the sintering behavior between the exterior regions and the interior region, which caused stress to remain inside the chip to lead to “NG” rating of the withstand voltage.

In Comparative Example 4, the element included as “RA” and the element included as “RB” were both Tb. Thus, it is assumed that, as similar to Comparative Example 1, in Comparative Example 4, this resulted in no concentration gradient of “RA” or “RB” from the exterior regions to the interior region, not allowing for reduction of difference in the sintering behavior between the exterior regions and the interior region, which caused stress to remain inside the chip to lead to “NG” rating regarding the withstand voltage.

According to the result of Example 7, even in the case that “RA” was Tb, high withstand voltage characteristic and IR characteristic were both attained, which was similar to Examples using Dy as “RA”.

### REFERENCE NUMERALS

2 . . . Multilayer ceramic capacitor
4 . . . Element main body
13 . . . Interior region
10 . . . Inner dielectric layer
12 . . . Inner electrode layer
13a . . . First interior region
13b . . . Second interior region
15 . . . Exterior region
11 . . . Outer dielectric layer
15a . . . First exterior region
15b . . . Second exterior region
6 . . . External electrode

What is claimed is:

1. A multilayer electronic device, comprising:
an element main body including an interior region where an inner dielectric layer and an inner electrode layer are laminated alternatingly and an exterior region positioned outside in a lamination direction of the interior region; and
a pair of external electrodes connected to the inner electrode layer on a surface of the element main body; wherein
the exterior region comprises a first exterior region and a second exterior region continuously in a lamination direction, where the first exterior region contains a second group of rare-earth elements in an amount greater than a first group of rare-earth elements, and the second exterior region contains the first group of rare-earth elements in an amount greater than that contained in the first exterior region;
the interior region has a higher concentration of the first group of rare-earth elements in the inner dielectric layer than a concentration of the first group of rare-earth elements in the exterior region;
the second exterior region and the interior region are adjacent to each other in the lamination direction; and
a thickness of the second exterior region is between 2 to 50 μm.

2. The multilayer electronic device according to claim 1, wherein
the interior region comprises a first interior region and a second interior region continuously in the lamination direction, where the first interior region has a concentration of the second group of rare-earth elements contained in the inner dielectric layer being consistently lower, along the lamination direction, than a concentration of the second group of rare-earth elements contained in second exterior region;
the second interior region has a concentration of the second group of rare-earth elements contained in the inner dielectric layer gradually increasing toward the exterior region compared to the concentration of the second group of rare-earth elements contained in the inner dielectric layer of the first interior region;
the second exterior region and the second interior region are adjacent to each other in the lamination direction; and
the concentration of the second group of rare-earth elements contained in the inner dielectric layer of the second interior region is lower than a concentration of the second group of rare-earth elements contained in the second exterior region.

3. The multilayer electronic device according to claim 2, wherein the concentration of the second group of rare-earth elements contained in the first exterior region is higher than the concentration of the second group of rare-earth elements contained in the second exterior region; and
a concentration of the first group of rare-earth elements contained in the second interior region is equal to or lower than a concentration of the first group of rare earth elements contained in the first interior region.

4. The multilayer electronic device according to claim 1, wherein a boundary between the first exterior region and the second exterior region is defined as a position along the lamination direction of the exterior region having a concentration of the first group of rare-earth elements which is an average of a peak intensity corresponding to the concentration of the first group of rare-earth elements of the inner dielectric layer positioned near a center in the lamination direction of the element main body of the interior region and a peak intensity corresponding to the concentration of the first group of rare-earth elements near an end in the lamination direction of the exterior region.

5. The multilayer electronic device according to claim 1, wherein
the first group of rare-earth elements comprises at least one selected from the group consisting of Dy, Yb, Ho, Tb, Gd, and Eu; and
the second group of rare-earth elements comprises Y.

6. A method for manufacturing a multilayer electronic device, comprising:
forming of an element main body comprising an interior region where an inner dielectric layer and an inner electrode layer are laminated alternatingly, and an exterior region positioned outside in a lamination direction of the interior region, wherein
the exterior region is formed by continuously laminating and baking, in a lamination direction, a first exterior green sheet corresponding to a first exterior region containing a second group of rare-earth elements in an amount greater than a first group of rare-earth elements, and a second exterior green sheet corresponding to a second exterior region containing the first group of rare-earth elements in an amount greater than in the first exterior region; and
the interior region is formed by laminating an interior green sheet containing the first group of rare-earth elements in an amount greater than that contained in the first exterior green sheet together with an electrode paste layer for forming the inner electrode layer, and by baking the first exterior green sheet and the second exterior green sheet together.

7. The method for manufacturing the multilayer electronic device according to claim 6, wherein a thickness of a single sheet or a plurality of sheets configuring the second exterior green sheet is 0.5 to 5 times of a thickness of a single sheet or a plurality of sheets configuring the interior green sheet positioned between the electrode paste layers adjacent to each other.
